(19) United States
(12) Patent Application Publication
(10) Pub. No.: US 2013/0117189 A1
(43) Pub. Date: May 9, 2013

(54) DETERMINING MOST PROBABLE RECONCILED REAL ESTATE VALUE USING MULTIPLE VALUATION EXPERTS

(71) Applicant: Valuation Vision LLC, Dover, DE (US)

(72) Inventors: William I. Mohler, III, Oceanside, CA (US); Ernest W. Durbin, II, Hamilton, OH (US)

(73) Assignee: Valuation Vision LLC, Dover, DE (US)

(21) Appl. No.: 13/667,439

(22) Filed: Nov. 2, 2012

Related U.S. Application Data
(60) Provisional application No. 61/555,791, filed on Nov. 4, 2011.

(51) Int. Cl. G06Q 50/16; G06Q 40/00

(52) U.S. Cl. 705/306

(57) ABSTRACT

A method and computer program product are disclosed to provide a single, reliable reconciled property valuation for a subject property when presented with multiple property valuation estimates from vendors, brokers, and/or agents. The method includes steps to store a plurality of independent property valuation estimates, identify a plurality of property characteristics that are common between the property valuation estimates, compute a property characteristic variance between the supporting sales comparables and/or competing listings and the subject property for each property valuation estimate, weight the property characteristic variances among the property valuation estimates for each property characteristic, and determine a most probable reconciled value by applying an algorithm to the weighted property characteristic variances.

### CROSS REFERENCE TO RELATED APPLICATION

Reference is made to and this application claims priority from and the benefit of U.S. Provisional Application Ser. No. 61/555,791 filed Nov. 4, 2011, entitled “DETERMINING REAL ESTATE VALUES USING MULTIPLE EXPERTS”, which application is incorporated herein in its entirety by reference.

### FIELD OF THE INVENTION

This disclosure relates generally to property valuation estimates and, more specifically, to reconciling multiple property valuation estimates having different values.

### BACKGROUND OF THE INVENTION

Traditionally, under certain circumstances, a real estate broker or agent is asked to provide an assessment of the price at which a particular piece of real property will likely sell. The broker or agent provides the assessment in what is known as a broker price opinion using various market factors. Forms for recording the various market factors, such as market conditions, employment conditions, the supply of properties on the market, property condition, comparable property selling prices and others have been developed and standardized by Fannie Mae, and others for use by the banking industry.

In the past, the broker or agent would provide a broker price opinion by relying on local market knowledge, comparable properties and other online resources to determine the potential sales price. By relying on a single broker or agent, the valuation is subject to the judgment of that single person. If that person tends to value property low or high, or errors in judgment on an individual assignment, the valuation will be inaccurate.

### SUMMARY OF THE INVENTION

When multiple property valuation estimates are provided by brokers, vendors, or agents for a subject property, a system and method are needed to provide a single, reliable reconciled property valuation for the subject property. In accordance with one aspect of the disclosure, a method for reconciling property valuation estimates for a subject property is provided. The method includes the steps of collecting a plurality of independent property valuation estimates, aggregating a set of supporting sales comparables and competitive listings, and identifying property characteristics that are common between the property valuation estimates. The method further includes the steps of computing a property characteristic variance between the supporting sales comparables and the subject property for each property valuation estimate, and computing, by one or more processors, an expert characteristic score from the property characteristic variances among the property valuation estimates for each property characteristic. The expert characteristic score is a weighted function of the property characteristic variances. The method further includes determining, by one or more processors, a most probable reconciled value by applying an algorithm to the plurality of independent property valuation estimates and the expert characteristic score.

In another aspect of the invention, a computer program product for reconciling property valuation estimates for a subject property is provided. The computer program product includes a computer readable storage medium having computer readable program code embodied therewith. The computer readable program code is configured to store a plurality of independent property valuation estimates and a set of supporting sales comparables, identify a plurality of property characteristics that are common between the property valuation estimates, compute a property characteristic variance between the supporting sales comparables/competitive listings and the subject property for each property valuation estimate, weight the property characteristic variances among the property valuation estimates for each property characteristic, and determine a most probable reconciled value by applying an algorithm to the weighted property characteristic variances.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 depicts a block diagram of a computer system having a computer readable storage medium, the computer system suitable for storing and/or executing computer code that implements various aspects of the present invention as described in greater detail herein;

FIG. 2 depicts a flow chart illustrating an exemplary method for reconciling property value appraisals, in accordance with one embodiment of the present invention; and

FIG. 3 depicts a flow chart illustrating an exemplary method for reconciling property value appraisals, in accordance with another embodiment of the present invention.

### DETAILED DESCRIPTION OF THE INVENTION

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Program code embodied on a computer-readable medium may be transmitted using any appropriate medium, including but not limited to wireless, wireline, optical fiber cable, RF, etc., or any suitable combination of the foregoing.

Computer program code for carrying out operations of the present invention may be written in any combination of one or more programming languages, including an object oriented programming language such as PHP, Javascript, Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

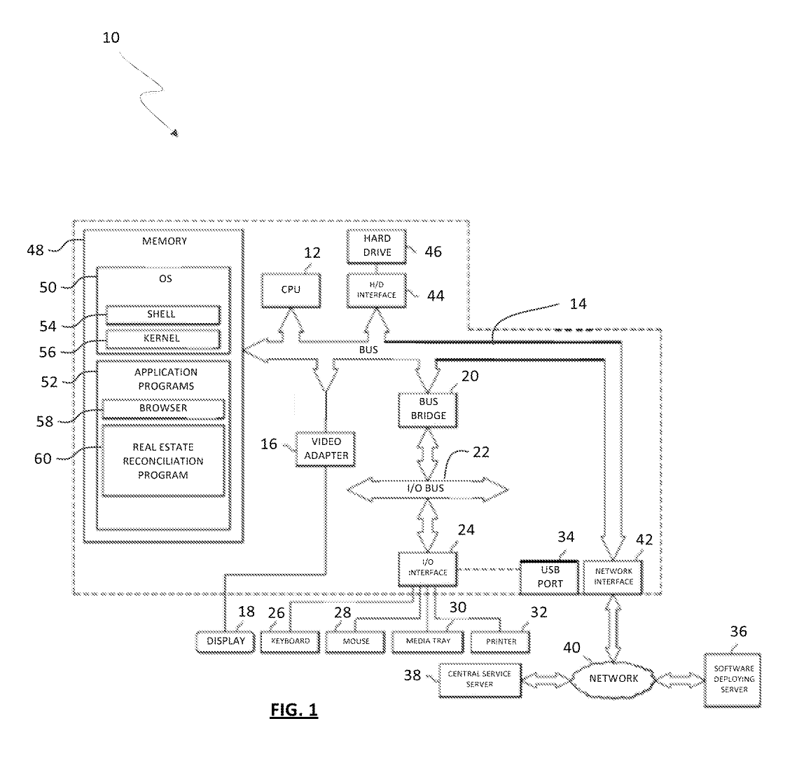

With reference now to the figures, and in particular, with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a block diagram of a computer 10 having a computer readable storage medium which may be utilized by the present disclosure. The computer system is suitable for storing and/or executing computer code that implements various aspects of the present invention. Note that some or all of the exemplary architecture, including both depicted hardware and software, shown for and within computer 10 may be utilized by a software deploying server and/or a central service server.

Computer 10 includes a processor (or CPU) 12 that is coupled to a system bus 14. Processor 12 may utilize one or more processors, each of which has one or more processor cores. A video adapter 16, which drives/supports a display 18, is also coupled to system bus 14. System bus 14 is coupled via a bus bridge 20 to an input/output (I/O) bus 22. An I/O interface 24 is coupled to (I/O) bus 22. I/O interface 24 affords communication with various I/O devices, including a keyboard 26, a mouse 28, a media tray 30 (which may include storage devices such as CD-ROM drives, multi-media interfaces, etc.), a printer 32, and external USB port(s) 34. While the format of the ports connected to I/O interface 24 may be any known to those skilled in the art of computer architecture, in a preferred embodiment some or all of these ports are universal serial bus (USB) ports.

As depicted, computer 10 is able to communicate with a software deploying server 36 and central service server 38 via network 40 using a network interface 42. Network 40 may be an external network such as the Internet, or an internal network such as an Ethernet or a virtual private network (VPN).

A storage media interface 44 is also coupled to system bus 14. The storage media interface 44 interfaces with a computer readable storage media 46, such as a hard drive. In a preferred embodiment, storage media 46 populates a computer readable memory 48, which is also coupled to system bus 14. Memory 48 is defined as a lowest level of volatile memory in computer 10. This volatile memory includes additional higher levels of volatile memory (not shown), including, but not limited to, cache memory, registers and buffers. Data that populates memory 48 includes computer 10's operating system (OS) 50 and application programs 52.

Operating system 50 includes a shell 54, for providing transparent user access to resources such as application programs 52. Generally, shell 54 is a program that provides an interpreter and an interface between the user and the operating system. More specifically, shell 54 executes commands that are entered into a command line user interface or from a file. Thus, shell 54, also called a command processor, is generally the highest level of the operating system software hierarchy and serves as a command interpreter. The shell 54 provides a system prompt, interprets commands entered by keyboard, mouse, or other user input media, and sends the interpreted command(s) to the appropriate lower levels of the operating system (e.g., a kernel 56) for processing. Note that while shell 54 is a text-based, line-oriented user interface, the present disclosure will equally well support other user interface modes, such as graphical, voice, gestural, etc.

As depicted, operating system (OS) 50 also includes kernel 56, which includes lower levels of functionality for OS 50, including providing essential services required by other parts of OS 50 and application programs 52, including memory management, process and task management, disk management, and mouse and keyboard management.

Application programs 52 include a renderer, shown in exemplary manner as a browser 58 146. Browser 58 includes program modules and instructions enabling a world wide web (WWW) client (i.e., computer 10) to send and receive network messages to the Internet using hypertext transfer protocol (HTTP) messaging, thus enabling communication with software deploying server 36 and other described computer systems.

The hardware elements depicted in computer 10 are not intended to be exhaustive, but rather are representative to highlight components useful by the present disclosure. For instance, computer 10 may include alternate memory storage devices such as magnetic cassettes (tape), magnetic disks (floppies), optical disks (CD-ROM and DVD-ROM), and the like. These and other variations are intended to be within the spirit and scope of the present disclosure.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In one embodiment of the invention, application programs 52 in computer 10's memory (as well as software deploying server 36's system memory) also include a property value reconciliation program 60. In property value valuation, reconciliation is the process of reducing several differing value indications or appraisal values into an appropriate conclusion. Ideally, the conclusion is a single value. This process involves an analysis of various criteria to form a meaningful, defensible conclusion about the final value opinion.

The present invention provides a system, method, and computer program product for more accurately assessing the price at which a property will sell. In one embodiment, the system utilizes multiple brokers, agents or other experts to estimate property value, each using what is known as the “desktop method.” In other embodiments, some experts utilize a property visit in addition to the desktop method. Each expert determines the estimated value based on local market knowledge, comparable properties and other online resources to determine a potential sales price. The multiple valuations are then analyzed and reconciled either through an automated process or manually to determine a single property valuation. The reconciliation process is done by analyzing the comparable properties selected by each valuation expert in the valuation process. The characteristics of the comparable properties selected by the experts are measured to compute a variance relative to the subject property across the various factors. The experts who have selected the most accurate comparable properties, defined by the lowest characteristic variance relative to each factor assessed, are identified either automatically or manually.

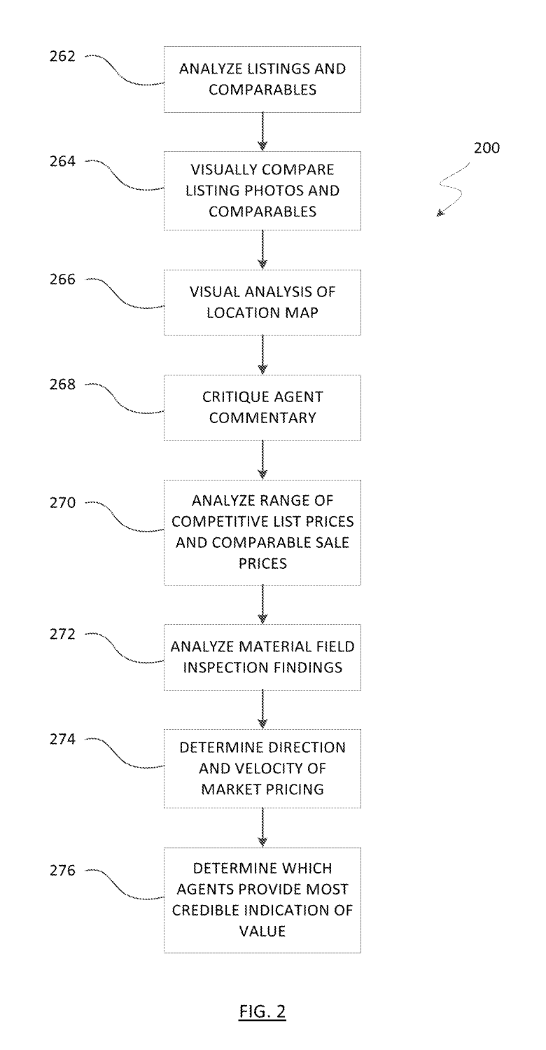

The process involves an analysis of the quality of data and the appropriateness of the methodology applied in the valuation process. In one embodiment, illustrated in FIG. 2, a method 200 for property value reconciliation includes a step 262 of analyzing the listings and comparables furnished by each expert in reference to the subject property. Factors that influence the analysis could include, for example, the similarity between the subject property and the additional property listing; the distance between the subject property and the additional property listing; the degree of similarity between external influences (i.e., power lines, nearby schools); the degree of similarity in “curb appeal;” the difference in quality between the subject property and the additional property listing; and whether the characteristics of the listings and comparables furnished by each expert bracket the subject property both positively and negatively.

The method 200 for property value reconciliation may further include a step 264 of visually comparing the comparables and listing photographs provided by the agents to determine quality similarity with the subject.

The method 200 for property value reconciliation may further include a step 266 comprising a visual analysis of the location map provided by the agents or experts to determine external influences and their impact on real estate value. This analysis would also test for appropriate selection of comparables and listings within the subject market segment.

The method 200 may further include a step 268 of critiquing commentary made by the agents or experts and the appropriateness of their valuation methodology.

The method 200 may further include a step 270 of analyzing the range of competitive list prices and comparable sale prices for the additional property listings and the subject property's value indication inside of that range.

The method 200 may further include a step 272 of analyzing the field inspection of the subject property to determine if the agents and experts properly considered material findings in their valuation process.

The method 200 may further include a step 274 of analyzing competitive list prices for the additional property listings and their relationship to comparable sale prices to determine the general direction of property values and their velocity of change.

The method 200 further includes a step 276 of making a final determination of which agents or experts provide the most credible indication of value. This is based on a holistic qualitative analysis.

Although the manual reconciliation of multiple values on a subject property according to method 200 can be useful and may be advantageous for certain applications, it suffers from drawbacks. One drawback is that the method is a time-consuming process, usually performed by an appraiser or professional who reviews multiple values and supporting evidence (e.g., sales comparables, local market trends, etc.) to determine the most likely value. Another is the potential for human error when manually reconciling numeric values.

In another embodiment of the invention, automatic value reconciliation can be used to determine the most accurate property estimate from a given set up estimates and supporting documentation. An automatic reconciliation process provides instant results using statistically relevant processes to determine the most likely property valuation from the evidence supplied.

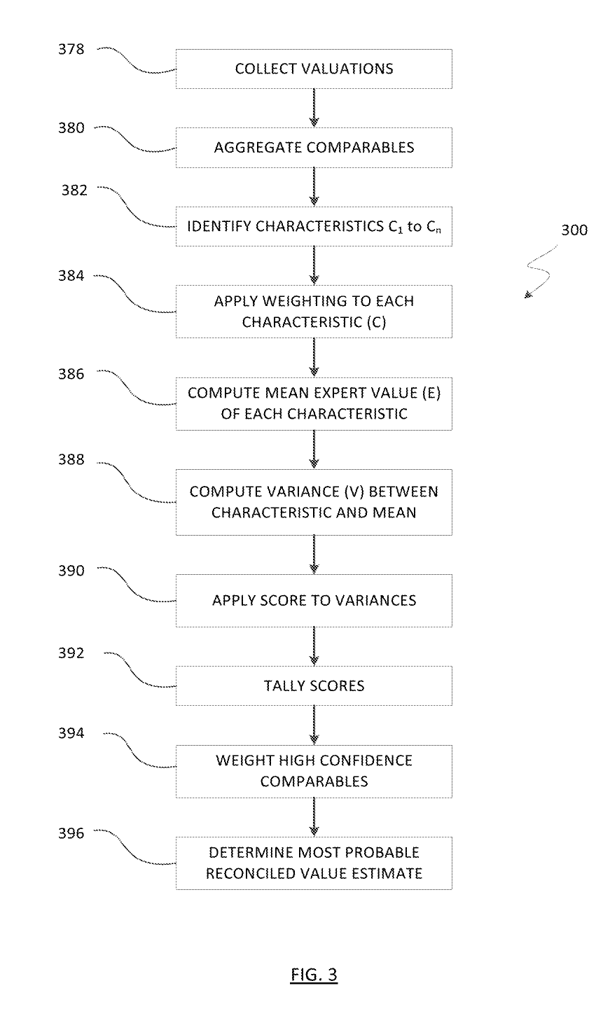

FIG. 3 depicts a flow chart of a method 300 for reconciling property value appraisals for a subject property according to another embodiment of the invention. The method 300 includes a step 378 of collecting multiple independent property valuation estimates for reconciliation. The source of the property valuation estimates may be a real estate agent, a professional property appraiser, or one or more valuation estimates generated by an automated valuation model (AVM), for example. As used herein, the sources may be referred to as vendors, brokers, or agents. Typically, the various property valuation estimates differ, sometimes drastically, and there is a need to reconcile which one of the estimates most accurately reflects the selling price of the subject property. In one implementation of the method 300, there are multiple property valuation estimates provided by multiple separate vendors that can be stored in memory 48 (FIG. 1). As used herein, a property valuation estimate refers to the market price, value, or estimate provided by a market expert, and is denoted by Pₙ, where n is the number of experts in the reconciliation.

The method 300 further includes a step 380 of aggregating the supporting sales comparables and competing listings furnished with each property valuation estimate. The estimates include multiple comparable properties, or comps, with characteristics that are deemed similar to the subject property whose value is being sought. Accordingly, the method 300 includes a step 382 of identifying property characteristics (C) that are common between all the property valuation estimates. The property characteristics can be obtained or drawn from a variety of sources and may include, but are not limited to: proximity to subject, closing sale date, days on market, sales comparable listed price, sales comparable sold price, gross living area, number of bedrooms, number of bathrooms, lot size, and age of home. The property characteristics that are available may vary by market or valuation method(s).

The process of placing a monetary value on a parcel of real estate can involve subjective determinations as to which of the property characteristics are more important than others. The subjective determinations can vary by region, market, or even neighborhood. For example, a property characteristic such as water views can be very important in an ocean-side community, but of less relevance for inland communities. Or, property characteristics such as lot size or number of bathrooms may be of more relevance to the subject property valuation than the age of the home. In many housing markets, the distance or proximity to the subject property is typically a much higher determinate of property comparability than the number of bathrooms. In a highly urban area, square footage might be a much higher determinate of property value as compared to proximity to the subject property.

In an effort to keep the characteristics in perspective, the method 300 may include a step 384 of weighting each comparable property characteristic to indicate how important it is to the value of the subject property. The property characteristic weighting Wₙ can be determined by a number of methods including, but not limited to, expert or professional experience or correlation methods. In one embodiment of the invention, the property characteristic weighting is represented by a numerical scale of values. In one example, the numerical scale is from 1 to 20, wherein each property characteristic is assigned a weighted value between 1 and 20. In one application, the property characteristic ‘Proximity to Subject’ of the comparable is assigned a scaled weighting of 10, while the property characteristic ‘Bedroom Count’ is assigned a weighting of 5. These weightings indicate proximity to the subject property is two times more important than the number of bedrooms when assessing the reliability of a property valuation estimate.

In another example, the weighting is binary. One application of binary weighting may be markets where waterfront or property view information is available, which may be a much higher determinate of overall property value. This ‘water view’ property characteristic may be binary instead of scaled, that is, YES there is a water view or NO there is not (in programming language this may be represented by a 0 or a 1).

Table 1 illustrates an example of data that may be provided for an automated value reconciliation process. As noted, the property characteristic weighting (W) can vary from market to market, and can be adapted to those market conditions. Any number of property characteristics can be used and weighted as long as each characteristic is present in each property valuation estimate. Also shown in Table 1 is the Subject Value (S) or amount for the particular characteristic (C). Note that the subject value for Proximity is 0, as distances are all measured from the subject.

TABLE 1

| | Prop. Char. | |
|---|---|---|
| | Weighting | Subject Value |
| Property Characteristic (C) | (W) | (S) |
| Proximity to Subject (C₁) | 10 (W₁) | 0 miles (S₁) |
| Bedroom Count (C₂) | 5 (W₂) | 4 rooms (S₂) |
| C₃ | W₃ | S₃ |
| C₄ | W₄ | S₄ |
| Cₙ | Wₙ | Sₙ |

In the example given above, an analysis of a housing market revealed that the property characteristic ‘Proximity to Subject’ (e.g., C₁) is two times more important to the value of a subject property than the characteristic of ‘Bedroom Count’ (e.g., C₂).

To determine which vendor- or expert-supplied property valuation estimates (P) have supporting data most similar to the subject property, the mean value of each property characteristic Cₙ can be calculated for each expert-provided valuation estimate. Stated another way, a Mean Expert Value (Ēₙ) can be calculated as the mean value of all values provided by each expert for that property characteristic, where n denotes the number of expert valuations used in the determination. Then, an Absolute Variance to Subject (Vₙ) can be determined between the mean expert value (Ē) and the subject value (S) of the property. The variances can be compared among the other expert's property valuation estimates, with the lowest absolute variance indicating which vendor or agent selected an overall comparable set most similar to the subject property. Any number of comparables can be used by each vendor or agent to create the mean value. Table 2 shows some exemplary input data for calculating the mean value. The values given to each Cₙₘ are the individual comparables property characteristic values, wherein n denotes the property characteristic number and m denotes the comp number. One such table could be constructed for each expert's property valuation estimate.

TABLE 2

| Property | | | | | |
|---|---|---|---|---|---|
| Charac- | Compar- | Compar- | Compar- | Compar- | Compar- |
| teristic | able 1 | able 2 | able 3 | able 4 | able m |
| C₁ | C₁₁ | C₁₂ | C₁₃ | C₁₄ | C₁ₘ |
| C₂ | C₂₁ | C₂₂ | C₂₃ | C₂₄ | C₂ₘ |
| Cₙ | Cₙ₁ | Cₙ₂ | Cₙ₃ | Cₙ₄ | Cₙₘ |

Equation (1) provides an exemplary calculation of a mean expert value (Ē) for the property characteristic C₁ for a first Expert A. The mean value can be computed for each comparable characteristic in the valuation at a step 386.

$${\overline{E}}_{A} = \frac{{c}_{11} + {c}_{12} + {c}_{13} + {c}_{14} + {c}_{1 m}}{m} \qquad ( 1 )$$

The calculated mean expert value data can be used as input to a step 388 to compute the variance (V) between the mean values and the subject property. In the illustrated embodiment, step 388 compares the mean comparable characteristics values to the subject property. In other embodiments, a variance is calculated using only the comparable property characteristics (without calculating a mean value). Equation (2) below illustrates one exemplary calculation for the Variance to Subject of Expert A, which can be a simple mathematical difference. In many circumstances the absolute value IVI is used, as the difference from the subject value is more important than whether it is higher or lower.

V_{A}=Ē_{A}−S (2)

In another example, the variance can be expressed as a percentage to provide an indication as to which of the comparable property characteristics most closely match that of the subject property. Equation (3) provides an exemplary calculation of the variance (V) for the property characteristic C₁. This can be repeated for each property characteristic in the value estimate, and for each property valuation estimate in the reconciliation.

$${( V )}_{{c}_{1}} = \frac{{s}_{1} - {( \overline{E} )}_{{c}_{1}}}{{s}_{1}} = for each expert valuation \qquad ( 3 )$$

In an effort to determine which property valuation estimates use supporting data (e.g., comps) that are most similar to the subject property, the method 300 may further include a step 390 of applying an Expert Characteristic Score (S) to the variances between the mean expert value (Ē) and the corresponding subject value (S). In one example, the Expert Characteristic Score is a weighted function of the variance. The weighted function can be determined, for example, by weighting an Expert Rank (R) applied to each variance.

The lowest absolute variance (V) amongst the Experts for each property characteristic indicates which vendor or agent is closest to the subject property characteristic Cₙ. Each Expert can be ranked on how closely their Mean Expert Value is in relation to the Subject Value, indicated by the lowest Absolute Mean Variance (V). In one example, the Expert with the lowest Absolute Mean Variance can be assigned an Expert Rank (R) value of 1, the second lowest can be assigned an Expert Rank value of 2, etc. Table 3 below illustrates this concept. For the property characteristic ‘Proximity to Subject’ (e.g., C₁), Expert A had an absolute variance (V) of 1 mile, and Expert B had an absolute variance of 3.5 miles. Thus, Expert A is assigned an Expert Rank value (R) of 1, and Expert B is assigned and Expert Rank value (R) of 2. If more than two experts were used, they would assigned expert rank values of 3, 4, etc. Similarly, for the property characteristic ‘Bedroom Count’ (e.g., C₂), Expert A had an absolute variance (V) of 2 rooms, and Expert B had an absolute variance of 1 room. Accordingly, Expert B is assigned an Expert Rank value (R) of 1, and Expert A is assigned and Expert Rank value (R) of 2.

A Ranking Value (RV) may be assigned to each expert's property characteristic to give weight to their expert rankings. In the general, the weighting follows an inverse relationship to the expert rank (R). That is, the lower (e.g., more favorable) the expert rank, the more weight or credence is given to that comparable property characteristic. In the example provided in Table 3, agents with an Expert Rank of 1 may be assigned a 3, while a rank of 2 may be assigned a 1. This provides those experts having the lowest absolute variance an overall higher composite score. In the event more than two Experts are utilized, the Ranking Value may take on different values. For example, if three experts are utilized, agents with an Expert Rank (R) of 1 for a particular property characteristic may be assigned a 5, a rank of 2 may be assigned a 3, and a rank of 3 may be assigned a 1.

TABLE 3
Expert A

| | | | | Absolute | | | Expert |
|---|---|---|---|---|---|---|---|
| | Property | | Mean | Variance to | | | Char. |
| Property | Char. | Subject | Expert | Subject | Expert | Ranking | Score |
| Char. | Weighting | Value | Value | (V_{A}) | Rank | Value | (S_{A}) |
| (C) | (W) | (S) | (E_{A}) | \|E-S\| | (R) | (RV) | W * RV |
| Proximity | 10 | 0 miles | 1 mile | 1 mile | 1 | 3 | 30 |
| To | | | | | | | |
| Subject | | | | | | | |
| Bedroom | 5 | 4 rooms | 2 rooms | 2 rooms | 2 | 1 | 5 |
| Count | | | | | | | |

| | |
|---|---|
| Total Composite Weight (T_{A}) | 35 |

Expert B

| | | | | Absolute | | | Expert |
|---|---|---|---|---|---|---|---|
| | Property | | Mean | Variance to | | | Char. |
| Property | Char. | Subject | Expert | Subject | Expert | Ranking | Score |
| Char. | Weighting | Value | Value | (V_{B}) | Rank | Value | (S_{B}) |
| (C) | (W) | (S) | (E_{B}) | \|E-S\| | (R) | (RV) | W * RV |
| Proximity | 10 | 0 miles | 3.5 miles | 3.5 miles | 2 | 1 | 10 |
| To | | | | | | | |
| Subject | | | | | | | |
| Bedroom | 5 | 4 rooms | 3 rooms | 1 room | 1 | 3 | 15 |
| Count | | | | | | | |

| | |
|---|---|
| Total Composite Weight (T_{B}) | 25 |

In one embodiment of the invention, the Expert Characteristic Score (S) is calculated for each property characteristic (C) by multiplying the Property Characteristic Weighting (W) by the Ranking Value (RV). This method accounts for the relative importance of the property characteristic (C) and the Expert's accuracy in finding comparables to the Subject Value (S) of the property characteristic. As shown in Table 3, Expert A received a higher composite score (S) for the ‘Proximity to Subject’ characteristic, while Expert B received a higher score (S) for the ‘Bedroom Count’ characteristic.

In another embodiment of the invention, the Expert Characteristic Score (S) could be calculated proportional to the distance from the closest mean variance. For example, the lowest Absolute Variance to Subject (V) can be assigned a score (S) of 1 (or unity). Other property value estimates whose variance from Cₙ are greater could be assigned a proportionately lower score (e.g., S is less than unity). That is, rather than assigning a sequential expert rank value (e.g., 1, 2, 3, etc.), the value could be proportional to its distance from the closest mean variance. In this manner, the expert rank values are proportionately weighted and the Ranking Value (RV) is not needed. Each row in Table 4 lists the variances Vₙₘ corresponding to a single property characteristic Cₙ. The variances can then be ordered from smallest to largest across each row, indicating which (PVE)ₘ provided comparables with the closest value to Cₙ. The variances in each row can then be scored or weighted based upon the ordering. For example, if |V₁₁|<|V₁₂|<|V₁₃|, then |V₁₁| receives the highest score, |V₁₂| receives a weaker score, and so on. In one embodiment of the invention, the scores or weightings for the remaining variances can be decreased proportionately. For example, if |V₁₁| had the lowest variance, a score (S₁₁)=1 (or unity) could be assigned. If |V₁₂| had the next lowest variance, a score (S₁₂) could be computed that was proportionately lower. Similarly, if |V₁₃| had the next lowest variance, a score (S₁₃) could be computed that was proportionately lower:

S₁₁=1 (3)

S₁₂=S₁₁−(V₁₁−V₁₂). (4)

S₁₃=S₁₁−(V₁₁−V₁₃). (5)

TABLE 4

| Property | Value | Value | Value | Value |
|---|---|---|---|---|
| Characteristic | Estimate | Estimate | Estimate | Estimate |
| (C) | (PVE)₁ | (PVE)₂ | (PVE)₃ | (PVE)ₘ |
| C₁ | V₁₁ | V₁₂ | V₁₃ | V₁ₘ |
| C₂ | V₂₁ | V₂₂ | V₂₃ | V₂ₘ |
| Cₙ | Vₙ₁ | Vₙ₂ | Vₙ₃ | Vₙₘ |

The method 300 for reconciling property valuation estimates further includes a step 392 to tally the Expert Characteristic Scores (S) for each property value estimate to arrive at a Total Composite Weight (T) that is used to reconcile each property value estimate. Table 3 and Equation 6 illustrate one implementation of scored property characteristics and the resulting summary calculation Tₙ:

T_{A}=ΣS_{A} for Expert A, Expert B, etc. (6)

The Total Composite Weight calculation Tₙ thus provides a composite weighting for each Expert that includes the relative importance of each property characteristic (Wₙ) as well as an indication of how close each of the Expert's comps were to the subject property (Sₙ). Any given valuation table could contain unique property characteristics, value estimates, and scores depending on property characteristics available in a given market.

The method 300 includes a final step 396 of determining the Most Probable Reconciled Value (M) from the plurality of property valuation estimates, using the scored and weighted comparable data. The Most Probable Reconciled Value uses all the weighted values provided by the experts to determine a likely value for the subject property. In one embodiment of the invention, the Most Probable Reconciled Value (M) can be calculated according to Equation 7:

$$M = \frac{Σ ( {P}_{n} \times {T}_{n} )}{Σ T} ; \qquad ( 7 )$$

where Pₙ denotes the Expert Provided Price/Value (e.g., the market price, value, or estimate provided by market Expert A, Expert B, etc.).

Table 5 provides an exemplary calculation of the Most Probable Reconciled Value using the two experts above.

TABLE 5

| | Expert Provided | Total Composite | |
|---|---|---|---|
| | Price (P) | Weight (T) | P * T |
| Expert A | $125,000 | 35 | 4375000 |
| Expert B | $100,000 | 25 | 2500000 |
| | Σ | 60 | 6875000 |
| | | M = Σ (P * T)/Σ T | $114,583.33 |

As can be appreciated with reference to Table 5, the provided price given by Expert A was given more weight or credence than Expert B because Expert A′s comparables were closer to the subject property. Thus, the Most Probable Reconciled Value is not merely split between the two expert provided prices, but is skewed closer to Expert A.

One factor that may be useful in reconciling property value estimates is identifying common comparables that were selected for use in multiple property value estimates by different vendors or agents. Because such common comparables were derived from several independent sources, they are reliable indicators of price or value for the subject property. The high probability of representing similarity to the subject property allows the common (or high confidence) comparables to be given special consideration or weighting in the reconciliation analysis. High confidence comparables can be identified using a variety of methods, depending on the data available. For example, street address, geocoded latitude and longitude, assessor's parcel number, and legal description can be utilized. A match found between two comparables then identifies it as a high confidence comparable.

The number of high-confidence comparables contained in each property valuation estimate provides additional support as to the confidence in that value assessment. In a step 394, property valuation estimates with a large percentage of high-confidence comparables can be weighed more heavily in the overall most probable reconciled value estimate (M). The weighting given to high confidence comparables can be determined by valuation experts and/or other statistical methods, and can vary depending on the market and comparable set size. In one embodiment of the invention, the weighted high confidence comparables can be expressed as:

Hₙ=(number of high confidence comparables)×(market weighting) (8)

In another embodiment of the invention, Equation (9) provides the framework for determining the Most Probable Reconciled Value (M). Equation (9) mathematically represents the most probable reconciled value. In this example n represents the total number of valuations being reconciled.

$$M = \frac{{E}_{A} ( {T}_{A} + {H}_{A} ) + {E}_{B} ( {T}_{B} + {H}_{B} ) + {E}_{C} ( {T}_{C} + {H}_{C} )}{n ( ( {T}_{A} + {T}_{B} + {T}_{C} ) + ( {H}_{A} + {H}_{B} + {H}_{C} ) )} \qquad ( 9 )$$

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

What is claimed is:

1. A method for reconciling property valuation estimates for a subject property, comprising the steps of:
collecting a plurality of independent property valuation estimates;
aggregating a set of supporting sales comparables;
identifying property characteristics that are common between the property valuation estimates;
computing a property characteristic variance between the supporting sales comparables and the subject property for each property valuation estimate;
computing, by one or more processors, an expert characteristic score from the property characteristic variances among the property valuation estimates for each property characteristic, the expert characteristic score being a weighted function of the property characteristic variances; and
determining, by one or more processors, a most probable reconciled value by applying an algorithm to the plurality of independent property valuation estimates and the expert characteristic score.

2. The method of claim 1, further comprising the step of weighting each comparable property characteristic to indicate its importance to the value of the subject property.

3. The method of claim 1, further comprising the step of weighting high confidence comparables and using the weighting in the step of determining a reconciled value estimate.

4. The method of claim 1, further comprising the step of determining, by one or more processors, an expert rank from the property characteristic variance.

5. The method of claim 4, further comprising the step of determining a ranking value from the expert rank, the expert characteristic score computed from the ranking value.

6. The method of claim 1, further comprising the step of computing a mean expert value for each property characteristic.

7. The method of claim 6, wherein the step of computing a property characteristic variance comprises calculating the mean expert value between the supporting sales comparables and the subject property.

8. The method of claim 1, further comprising the step of determining a total composite weight by tallying the expert characteristic scores for each property valuation estimate.

9. The method of claim 8, wherein the step of determining a most probable reconciled value uses the total composite weight as input.

10. The method of claim 1, wherein the algorithm accounts for the independent property valuation estimate's accuracy in finding supporting sales comparables similar to the subject property.

11. The method of claim 10, wherein the algorithm accounts for the independent property valuation estimate's accuracy in finding property characteristics similar to the subject property.

12. The method of claim 11, wherein the algorithm accounts for the relative importance of the property characteristics.

13. The method of claim 1, wherein the algorithm is expressed as Equation (7).

14. A computer program product for reconciling property valuation estimates for a subject property, comprising:
a computer readable storage medium having computer readable program code embodied therewith, the computer readable program code configured to:
store a plurality of independent property valuation estimates;
store a set of supporting sales comparables;
identify a plurality of property characteristics that are common between the property valuation estimates;
compute a property characteristic variance between the supporting sales comparables and the subject property for each property valuation estimate;
weighting the property characteristic variances among the property valuation estimates for each property characteristic; and
determine a most probable reconciled value by applying an algorithm to the weighted property characteristic variances.

15. The computer program product of claim 14, further including computer readable program code configured to weight each comparable property characteristic to indicate its importance to the value of the subject property.

16. The computer program product of claim 15, further including computer readable program code configured to use the weighted comparable property characteristic to determine the most probable reconciled value.

17. The computer program product of claim 16, further including computer readable program code configured to weight high confidence comparables and use the weighted high confidence comparables to determine the reconciled value estimate.

18. The computer program product of claim 14, further including computer readable program code configured to calculate a mean value of each property characteristic and use the mean value to determine the most probable reconciled value.

19. The computer program product of claim 14, further including computer readable program code configured to determine a total composite weight by tallying the weighted property characteristic variances for each property valuation estimate.

20. The computer program product of claim 14, wherein the algorithm is expressed as Equation (7).
